(19) United States
(12) Patent Application Publication
(10) Pub. No.: US 2006/0154613 A1
(43) Pub. Date: Jul. 13, 2006

(54) Method and circuit for producing and detecting a transmit signal

(76) Inventors: Dirk Hamm, Willich (DE); Marc Lenkeit, Willich (DE)

Correspondence Address: QUARLES & BRADY LLP, 411 E. WISCONSIN AVENUE, SUITE 2040, MILWAUKEE, WI, 53202-4497, US

(21) Appl. No.: 11/037,558

(22) Filed: Jan. 18, 2005

(30) Foreign Application Priority Data
Jan. 7, 2005 (EP) EP 05000254.2

(51) Int. Cl. H04B 1/00; H04B 7/00

(52) U.S. Cl. 455/68

(57) ABSTRACT

A method for producing and detecting a transmit signal for frequency-modulating (FM) audio transmission systems, in particular for audio radio transmission systems, includes transmitting a first signal component (useful signal) that comprises audio information, and transmitting a second signal component (additional signal) that contains status information and/or control information, wherein after FM demodulation, the second signal component comprises main spectral components below the audio information useful spectrum in the baseband of the transmit signal. This method can be achieved using a circuit including a programmable phase locked loop (PLL) that determines a transmit frequency, whose divider and/or counter register is periodically reprogrammed by a microcontroller in such a way that the unmodulated carrier of the transmit frequency is periodically deflected from its fundamental frequency.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates to a method and a circuit for producing and detecting a transmit signal for frequency-modulating (FM) audio transmission systems, in particular for audio radio transmission systems, in which the signal includes, in addition to a first signal component (useful signal) that comprises audio information, a second signal component (additional signal) that contains status and/or control information.

2. Description of the Prior Art

A large number of different designs for transmit and receive devices are known that transmit and detect additional information, such as control and status information in the transmit signal. These include, for example, the “tone squelch” and “pilot tone” methods. These methods require at least one special oscillator that produces one or more control signals (e.g. sine frequencies) that are superposed on the audio signal before a modulation stage or on the FM signal after a modulation stage. Before the FM modulation or after the FM demodulation, these additional signals (tones) are usually located within (e.g., 67 Hz to 250 Hz) or above (typically 18 kHz-25 kHz) the audio range within the baseband spectrum, and must be selected by the receiver for detection. The detected signals control for example the muting of a receiver, if the signal is not recognized, or the activation of a stereo decoder if the signal is recognized.

The methods cited above as prior art have a series of disadvantages:

If the control signals lie within the baseband useful spectrum, no useful signals can be transmitted in the range of these frequencies, which corrupts or reduces the useful spectrum.

If control signals located above the baseband useful spectrum are supplied to the audio signal before the modulation, i.e., they are frequency-modulated, an increased bandwidth requirement results for the transmit channel, in order to be able to transmit the audio signal simultaneously with no reduction in quality and to uniquely recognize the control signal. For a given transmit channel bandwidth, this requires a reduction of the modulation index, which results in the impairment of the attainable signal-to-noise ratio.

The use of individual pilot tones, which after the modulation stage are interleaved into the FM spectrum or are transmitted over a separate frequency band, requires additional transmit power, and, depending on the design, additional bandwidth. Additional transmit power results in an increase in the power consumption of the transmitter, and, in the case of battery-operated or accumulator-operated devices, a shortening of the maximum available operating time.

Therefore, there is a need for a method and a circuit for producing a transmit signal that in addition to the audio useful signal comprises an additional signal having status and/or control information and that does not have the aforementioned disadvantages.

### SUMMARY OF THE INVENTION

An object of the present invention is to create a method and a circuit of the type named above that ensures the simultaneous transmission of the useful signal and the additional signal without adversely affecting the useful signal.

A further object of the present invention is to create a method and a circuit of the type named above that ensure a reliable suppression of the additional signal, after demodulation of the transmit signal.

A further object of the present invention is to create a method and a circuit of the type named above that do not require any significant enlargement of the bandwidth of the transmit signal.

Another further object of the present invention is to create a method and a circuit of the type named above that will also ensure long operating times in battery or accumulator operation.

Finally, it is an object of the present invention to create a method and a circuit of the type named above that can be implemented using a minimum number of components.

These objects are achieved in a method including transmitting a first signal component (useful signal) that comprises audio information, and transmitting a second signal component (additional signal) that contains status information and/or control information, wherein after FM demodulation, the second signal component comprises main spectral components below the audio information useful spectrum in the baseband of the transmit signal, and are achieved with a circuit including a programmable phase locked loop (PLL) that determines a transmit frequency, whose divider and/or counter register is periodically reprogrammed by a microcontroller in such a way that the unmodulated carrier of the transmit frequency is periodically deflected from its fundamental frequency.

In order to meet the requirement of isochronous, high-quality audio transmission without reduction or corruption of the audio spectrum in the frequency range from 20 Hz to 20 kHz, according to the present invention a modulation frequency is produced that is located below the audio useful spectrum, preferably below 20 Hz, and especially preferred in the area of 5 Hz.

The reception and the FM demodulation of the produced transmit signal having a useful signal portion and an additional signal portion according to the invention does not differ significantly from standard transceiver designs for pure audio signal transmission. The coupling capacitors provided for the signals in the baseband must merely be designed in such a way that the signal component with the lowest frequency—that of the additional signal to be detected—has sufficient amplitude. After the FM demodulation and sufficient signal amplification, according to the present invention the audio useful signal and the additional signal, containing control and/or status information, are separated from one another by frequency filtering.

While the audio useful signal can be further processed by the receiver in the standard manner, for a reliable recognition it is advantageous to suitably prepare the additional signal, for example for control purposes and/or status displays. Here, special attention must be paid to the fact that interferences in the transmit channel or short-term instabilities of the transmitter modulator can result in unintended reception of very low-frequency spectral fractions. These low-frequency spectral fractions can also be located in the filter passband of the control channel, and can thus make a reliable recognition more difficult. Since it can be assumed that these interferences will occur only on a short-term basis, according to the present invention the detection reliability is improved by a longer signal observation time.

In an advantageous specific embodiment of the transmitter-side circuitry according to the invention, the divider and/or counter registers of a programmable phase locked loop (PLL) that determines the transmit frequency is periodically reprogrammed by a microcontroller in such a way that the unmodulated carrier is periodically deflected from its fundamental frequency. This deflection can occur symmetrically, e.g. with the switching sequence: [fo, (fo+df), fo, (fo−df)], and/or [fo, (fo+df), (fo−df), (fo+df), (fo−df), . . . , fo]), or asymmetrically, e.g. with the sequence: [fo, (fo+df)] and/or [fo, (fo−df)], (where fo=carrier center frequency of the unmodulated transmit signal, df=fixed frequency difference. In the case of asymmetrical controlling, with the associated shift of the carrier center frequency, care must be taken to maintain the required frequency tolerance).

The adjustable frequency raster of the PLL synthesizer determines the minimum frequency shift. The maximum frequency deviation is determined primarily by the divider change in the PLL synthesizer. The PLL loop filter and the adjustment of the PLL synthesizer charge pump for controlling the voltage-controlled oscillator (VCO) here influence the transient response of the PLL system, which itself has a direct influence on the frequency deviation produced in the VCO. The loop filter and the adjustment of the charge pump must be optimized in such a way that no overshooting of the VCO frequency is caused during the periodic changing of the divider and/or counter registers and overtones (harmonics of the fundamental frequency) in the VCO control signal are suppressed. According to the present invention, the produced VCO signal, which is modulated by the PLL synthesizer via the tuning voltage then has the characteristic features of a modulated FM signal at the VCO output.

In summarized form, the present invention is distinguished from the prior art by the following advantages:

The additional signal can be sent synchronously with a high-quality transmission of the audio useful signal, without reducing or corrupting the audio spectrum in the typical frequency range from 20 Hz to 20 kHz (useful signal integrity).

The control signal can be suppressed electrically in the receiver after the demodulation in such a way that it cannot be perceived via an electroacoustic transducer by the user. This applies irrespectively of whether or not an audio useful signal is simultaneously transmitted (control signal suppression/useful signal integrity).

The bandwidth of the transmit signal must not be significantly enlarged for the additional signal. Hereby, the signal-noise ratio of the demodulated audio useful signal also remains almost unaffected (required bandwidth/SNR). This typically results in an additional bandwidth requirement of 2 kHz, which can be regarded as insignificant in relation to the standard 200 kHz channel bandwidths (see description of Figures).

The energy consumption of the transmitter is independent of the transmission of the additional signal, which favorably affects the maximum operating time in battery-operated or accumulator-operated devices (max. operating time).

No additional oscillators are required for the production and detection of the additional signal, which favorably affects the component and energy requirement (component costs/max. operating time).

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

FIG. 1 shows a block diagram of a specific embodiment of the signal-producing part (transmitter-side) of the circuit according to the present invention;

FIG. 2 shows a block diagram of a specific embodiment of the signal-separating part (receiver-side) of the circuit according to the present invention;

FIG. 3 shows a spectrum of a transmit signal produced according to the present invention and transmitted by a transmitter, with a 1 kHz signal deviation (switchover in the 1 kHz raster);

FIG. 4 shows a baseband spectrum of the FM-demodulated transmit signal of FIG. 3, received by a receiver (i.e., the receive signal), with a 1 kHz signal deviation (switchover in the 1 kHz raster);

FIG. 5 shows a spectrum of a transmit signal produced according to the present invention and transmitted by a transmitter, with simultaneous modulation by an audio signal and an additional signal;

FIG. 6 shows a baseband spectrum of the FM-demodulated combined transmit signal from FIG. 5, received by a receiver (i.e., the receive signal);

FIG. 7 shows a spectrum of a transmit signal transmitted by a transmitter with modulation by an audio signal; and

FIG. 8 shows a baseband spectrum of the FM-demodulated transmit signal of FIG. 7, received by a receiver (i.e., the receive signal).

### DETAILED DESCRIPTION OF THE PREFERRED EMBODIMENTS

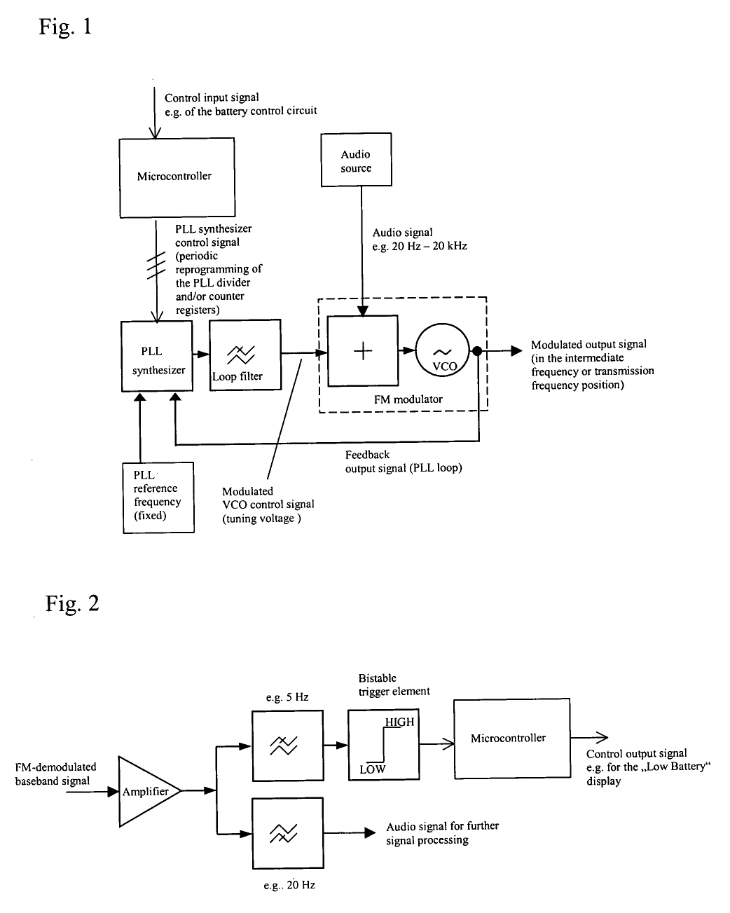

FIG. 1 shows, in the form of a block diagram, a specific embodiment of the transmitter-side circuit part of the circuit according to the present invention for producing a transmit signal for frequency-modulating (FM) audio transmission systems, in particular for audio radio transmission systems. The transmit signal includes, in addition to a first signal component (useful signal) that comprises audio information, a second signal component (additional signal) that contains status information and/or control information. FIG. 2 shows, also in the form of a block diagram, a specific embodiment of the receiver-side circuit part of the circuit according to the present invention for detecting the transmit signal produced in the transmitter-side circuit part of FIG. 1.

In the circuit part of FIG. 1, the divider and/or counter registers of a programmable phase locked loop (PLL) that determines a transmit frequency are periodically reprogrammed by a microcontroller in such a way that the unmodulated carrier is periodically deflected from its fundamental frequency. This deflection can occur symmetrically (e.g. with the switching sequence: [fo, (fo+df), fo, (fo−df)], or [fo, (fo+df), (fo−df), (fo+df), (fo−df), . . . , fo]) or asymmetrically, (e.g. with the sequence: [fo, (fo+df)] or [fo, (fo−df)]) (where fo=carrier center frequency of the unmodulated transmit signal, df=fixed frequency difference. In the case of asymmetrical controlling, with the associated shift of the carrier center frequency, care must be taken to maintain the required frequency tolerance). The adjustable frequency raster of the PLL synthesizer determines the minimum frequency deviation. The maximum frequency deviation is determined primarily by the divider change in the PLL synthesizer.

A PLL loop filter and the adjustment of the PLL synthesizer charge pump for controlling the voltage-controlled oscillator (VCO) here affect the transient response of the PLL system, which itself has a direct influence on the frequency deviation produced in the VCO. The loop filter and the adjustment of the charge pump must be optimized to the extent possible, such that no overshooting of the VCO frequency is caused during the periodic changing of the divider and/or counter registers and overtones (harmonics of the fundamental frequency) in the VCO control signal are suppressed. The produced VCO signal, which is modulated by the PLL synthesizer via the tuning voltage, then has, according to the present invention, the characteristic features of a modulated FM signal at the VCO output.

In order to ensure a synchronous, high-quality audio useful signal transmission without reduction or corruption of the audio signal spectrum in the useful frequency range from 20 Hz to 20 kHz, according to the present invention a VCO modulation frequency is produced that is located below the audio useful frequency range. In the exemplary embodiment of FIG. 1, the modulation frequency is for example 5 Hz.

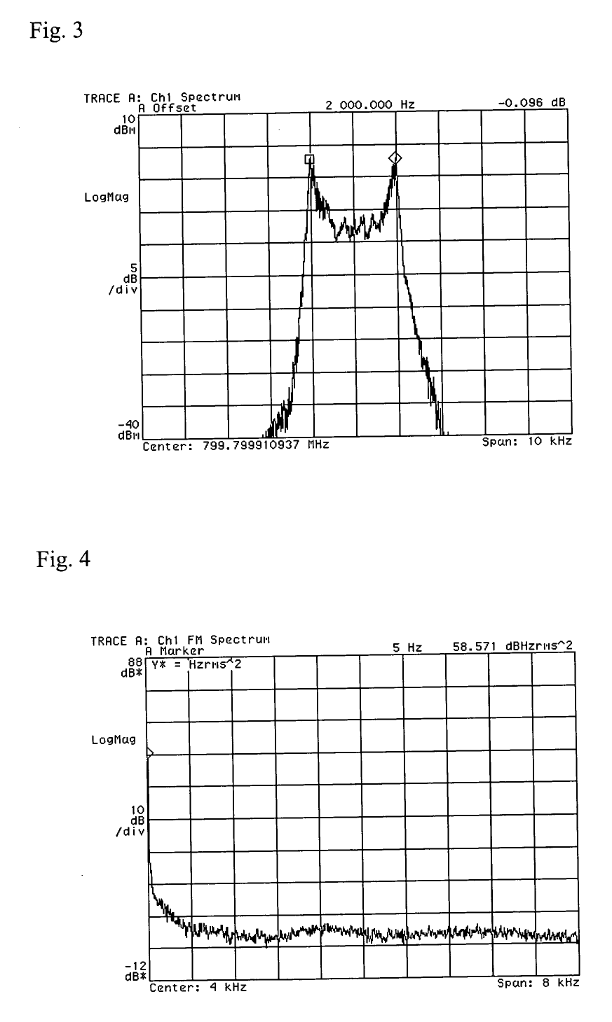

FIGS. 3 and 4 show the spectra of the transmit signal (FIG. 3) and of the FM-demodulated transmit signal received by the receiver (receive signal) (FIG. 4), with a transmitter-side frequency raster of 1 kHz and a periodic divider register change or counter register change of the PLL synthesizer, in the switching sequence [+1, −1, −1, +1], with a switching interval of 50 ms (loop filter and charge pump current optimized). The described transmit signal has a typical FM spectrum with a frequency deviation of 1 kHz.

The demodulated receive signal shows only one significant spectral line at 5 Hz. The remaining spectrum contains practically no additional spectral components. If the voltage-controlled oscillator (VCO) forms part of an audio FM modulator, for example in that the fed-in audio signal detunes the VCO frequency with a varactor diode in the oscillator resonance circuit, then both signals that determine the carrier frequency are superposed in the oscillator resonance circuit to form the combined FM transmit signal.

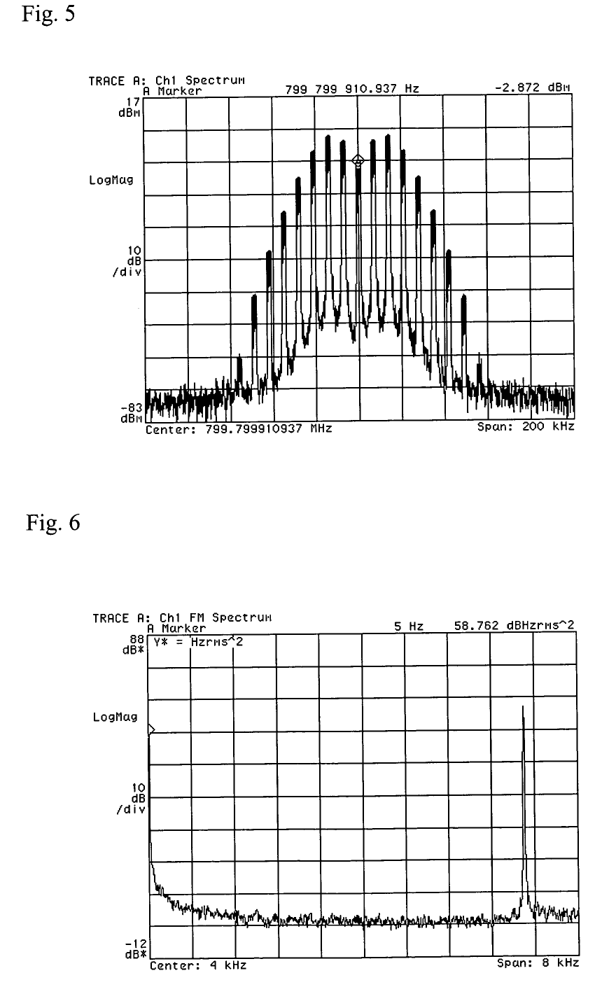

FIGS. 5 and 6 show the spectra of the above-described transmit signal (FIG. 5) and of the FM-demodulated receive signal (FIG. 6) with a transmitter-side frequency raster of 1 kHz, a periodic divider register change or counter register change of the PLL synthesizer in the switching sequence [+1, −1, −1, +1] with a switching interval of 50 ms, and with additional audio modulation (7 kHz sine). FIG. 6 shows the FM-demodulated receive signal in the baseband spectrum. The 5 Hz signal, which was produced by the switchover of the divider and/or counter registers in the PLL synthesizer and the 7 kHz audio signal are clearly evident. The remainder of the spectrum contains no significant spectral components.

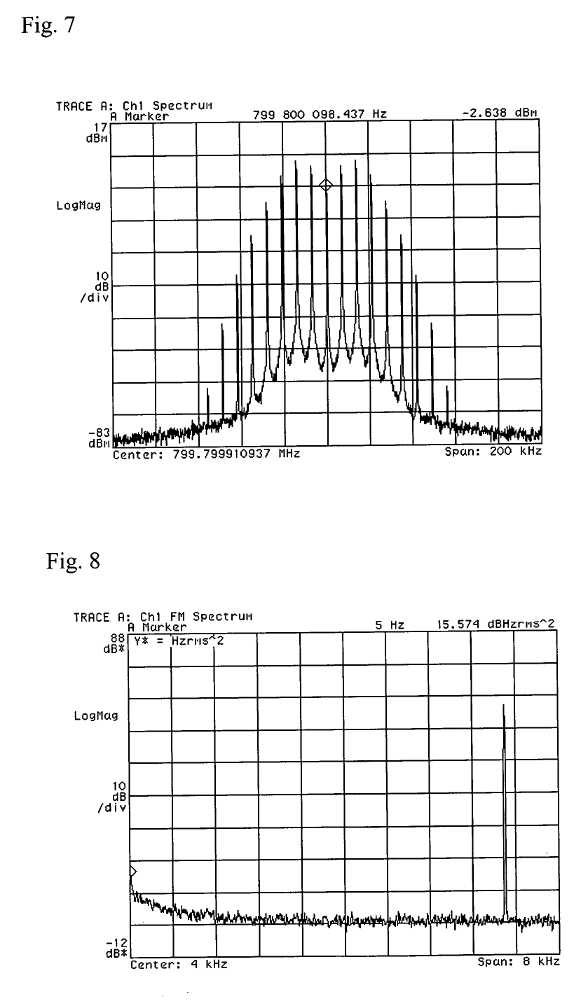

In comparison, FIGS. 7 and 8 illustrate the conditions of the transmit signal and the demodulated receive signal if only the 7 kHz audio signal is used for the modulation. The comparison shows that for the transmission of the control signal according to the present invention in this concrete case of application, there is an additional bandwidth requirement of approximately 2 kHz—i.e., a double PLL frequency raster. An additional bandwidth requirement of 2 kHz is to be considered insignificant in relation to the standard 200 kHz channel bandwidths.

By adjusting a different frequency raster, the frequency deviation, and thus the additional bandwidth requirement, can be changed and/or can be adapted to the transmission requirements (detection security, SNR, etc.). In particular, the symmetrical controlling with the same frequency raster can halve the additional bandwidth requirement. With asymmetrical controlling, and the associated shift of the carrier center frequency, care must be taken to maintain the required frequency tolerance.

The basic concept of the present invention also includes the production of the combined transmit signal at an intermediate frequency (IF); in this case, the produced spectrum must first be shifted into the actual transmit frequency band (e.g. with the aid of a frequency mixer) in further steps.

The reception and the FM demodulation of the transmit signal according to the present invention, as well as of the audio signal, do not differ significantly from standard receiver designs for pure audio transmission. Care must merely be taken that the coupling capacitors provided for the signals in the baseband are designed in such a way that the signal component having the lowest frequency—specifically, that of the control signal to be detected—has sufficient amplitude.

After the FM demodulation and sufficient signal amplification, the audio signal and the additional signal are separated from one another by frequency filtering. While the audio useful signal can be further processed in a standard manner, for a reliable recognition it is necessary to suitably prepare the inventive additional signal, for example for control purposes and/or status displays. Here, special attention must be paid to the fact that interferences in the transmit channel or short-term instabilities of the transmitter modulator can result in the unintended reception of very low-frequency spectral portions. These low-frequency spectral portions can also be located in the filter passband of the control channel, and can thus make a reliable recognition more difficult. Since it can be assumed that these interferences will occur only on a short-term basis, according to the present invention the detection reliability is improved by a longer signal observation time.

In the exemplary embodiment of FIG. 2, a 5 Hz low-pass filter with high edge steepness, followed by a bistable trigger element stage is used for the detection of the status signal or control signal after the FM demodulation and sufficient signal amplification. The trigger element is designed in such a way that only two stable output level states exist—where the one level status is located below the digital decision threshold for a LOW signal, while the other is located above the digital decision threshold for a HIGH signal—so that a connected microcontroller can interpret a change at its digital input port, specifically the change frequency of the HIGH and the LOW signals. If the transmit signal comprises spectral components in the passband of the low-pass filter, the status on the controller input pin changes corresponding to the adjacent frequency. By counting the registered status changes over an extended time period and comparing them with the expected status changes of the additional signal over the same time period, the additional signal can be uniquely detected according to the present invention. The basic idea of the present invention also includes other detection solutions, for example an analog-digital conversion of the demodulated signal and subsequent digital processing.

In order to separate the demodulated audio signal from the additional signal, a high-pass or bandpass filtering of sufficient edge steepness with a lower cutoff frequency of for example 20 Hz, is provided before the further audio signal processing.

While there has been shown and described what is at present considered the preferred embodiment of the invention, it will be obvious to those skilled in the art that various changes and modifications can be made therein without departing from the scope of the invention defined by the appended claims.

We claim:

1. A method for producing and detecting a transmit signal for frequency-modulating (FM) audio transmission systems, in particular for audio radio transmission systems, said method comprising:
transmitting a first signal component (useful signal) that comprises audio information; and
transmitting a second signal component (additional signal) that contains status information and/or control information, wherein after FM demodulation, the second signal component comprises main spectral components below the audio information useful spectrum in the baseband of the transmit signal.

2. The method according to claim 1, characterized in that after FM demodulation the main spectral components of the second signal component are located below 20 Hz.

3. The method according to claim 1, characterized in that after FM demodulation, the main spectral components of the second signal component are preferably located at approximately 5 Hz.

4. The method according to claim 1, characterized by the use of a longer-than-normal signal observation time at the receiver side in order to provide improved detection reliability of the FM-demodulated second signal component.

5. The method according to claim 1, characterized in that the second signal component is continuously transmitted and is interrupted only if this signal component is intended to trigger a function in the receiver, wherein a receiver receiving the transmit signal reacts to the non-recognition of the signal in terms of negative logic.

6. The method according to claim 1, characterized in that the second signal component is transmitted only if a function is to be triggered at the receiver, wherein a receiver receiving the transmit signal reacts to the signal recognition in terms of positive logic.

7. The method according to claim 5, characterized in that upon the reaction of the receiver a muting of the first audio muting signal component containing the audio information occurs.

8. The method according to claim 5, characterized in that upon the reaction of the receiver a transmitter-specific status is indicated.

9. A circuit for producing and/or detecting a transmit signal including first and second signal components, said circuit comprising:
a programmable phase locked loop (PLL) that determines a transmit frequency, whose divider and/or counter register is periodically reprogrammed by a microcontroller in such a way that the unmodulated carrier of the transmit frequency is periodically deflected from its fundamental frequency.

10. The circuit according to claim 9, characterized in that the carrier is produced by a voltage-controlled oscillator (VCO) in which the transmit signal is applied to the output.

11. The circuit according to claim 9, characterized by a loop filter that produces the control voltage for a voltage-controlled oscillator (VCO) and connects the phase detector output of a PLL synthesizer with the input that determines the oscillator-frequency of a VCO.

12. The circuit according to claim 11, characterized in that the loop filter for the production of the transmit signal is optimized in such a way that an FM demodulation of the transmit signal comprises only one significant spectral component below the useful audio spectrum in the baseband.

13. The circuit according to claim 9, characterized in that the PLL comprises an adjustable charge pump for determining the phase detector output current.

14. The circuit according to claim 13, characterized by an adjustment of the charge pump and thus of the phase detector output current that provides improved detectability of the FM-demodulated transmit signal.

15. The circuit according to claim 9, characterized in that the reprogramming of the divider or/or counter registers is selected so that the transmit signal is subjected to a symmetrical or asymmetrical frequency deflection in relation to the fundamental frequency and/or the unmodulated VCO frequency, in which the time interval between the minimum and maximum frequency deflection is specified so that after FM demodulation, the main spectral components of the second signal component, which comprises the status and/or control information, are located below the audio useful spectrum in the baseband.

16. The circuit according to claim 10, characterized in that the VCO is part of an audio FM modulator with one audio input, in order to detune a resonance circuit of the VCO by applying an audio signal so that a frequency-modulated signal is present on the output of the VCO.

17. The circuit according to claim 9, characterized in that after FM demodulation on the receiving side, a separation of the signal path into an audio signal path for the first signal component and a control/status signal path for the second signal component is provided.

18. The circuit according to claim 17, characterized in that a low-pass filter with preferably high edge steepness for signal selection is located in the signal path, comprising a cutoff frequency below the useful audio spectrum.

19. The circuit according to claim 18, characterized in that a bistable trigger element is connected to the low-pass filter, where the output is designed to only accept the logical states HIGH and LOW which can be interpreted by a microcontroller.

20. The circuit according to claim 19, characterized in that the microcontroller uses the change frequency of the HIGH and LOW status as a criterion for control/status signal detection.

21. The circuit according to claim 17, characterized in that a high-pass filter for signal selection that comprises a cutoff frequency above the spectrum of the control/status signal is located in the audio signal path.
